(19) United States
(12) Patent Application Publication
(10) Pub. No.: US 2017/0097662 A1
(43) Pub. Date: Apr. 6, 2017

(54) Inflatable Display

(71) Applicant: Occasions Ltd, Kowloon (HK)

(72) Inventor: Alan Siu Lun Chan, Kowloon (HK)

(73) Assignee: Occasions Ltd.

(21) Appl. No.: 14/876,685

(22) Filed: Oct. 6, 2015

(51) Int. Cl. G06F 1/16; G09F 19/00

(52) U.S. Cl. CPC G06F 1/1656; G09F 19/00; G06F 1/1654

(57) ABSTRACT

An inflatable display is disclosed. The inflatable display contains an inflatable outer shell containing at least one compartment configured to accommodate at least one display assembly, at least one fan providing a continuous air flow to inflate the inflatable outer shell, and at least one display assembly disposed within the at least one compartment and configured to display information.

### FIELD

The present invention relates to air-filed displays.

### BACKGROUND

Inflatable displays have a wide range of application, shape and size, including, but not limited to, figures for holiday and seasonal decoration, marketing, advertising, entertainment, and event attraction. The inflatable displays are made from a permeable fabric that allows air to pass through the fabric at approximately the same rate as the air being blown into the inflatable display. The process of continuously blowing air being supplied from a fan or other inflation device occurring at substantially the same rate as air escaping the fabric allows the display to maintain a three-dimensional shape without the use of an internal or external frame or structure. These are known in the industry as “cold-air” inflatable displays.

Typically, the cold-air inflatable display is a static figure formed from an inflation module which represents an individual figure when inflated. For example, a consumer may decide to decorate their house with a spider inflatable display for the Halloween season or a Santa Clause inflatable display for the holiday season. One of the limitations of the cold-air inflatable display is that they are static.

Presently disclosed embodiments overcome the limitations of the prior art.

### BRIEF DESCRIPTION OF THE FIGURES

FIGS. 1a-b and 2 depict an embodiment according to the present disclosure.

FIG. 3 depicts a display assembly according to some embodiments presently disclosed.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

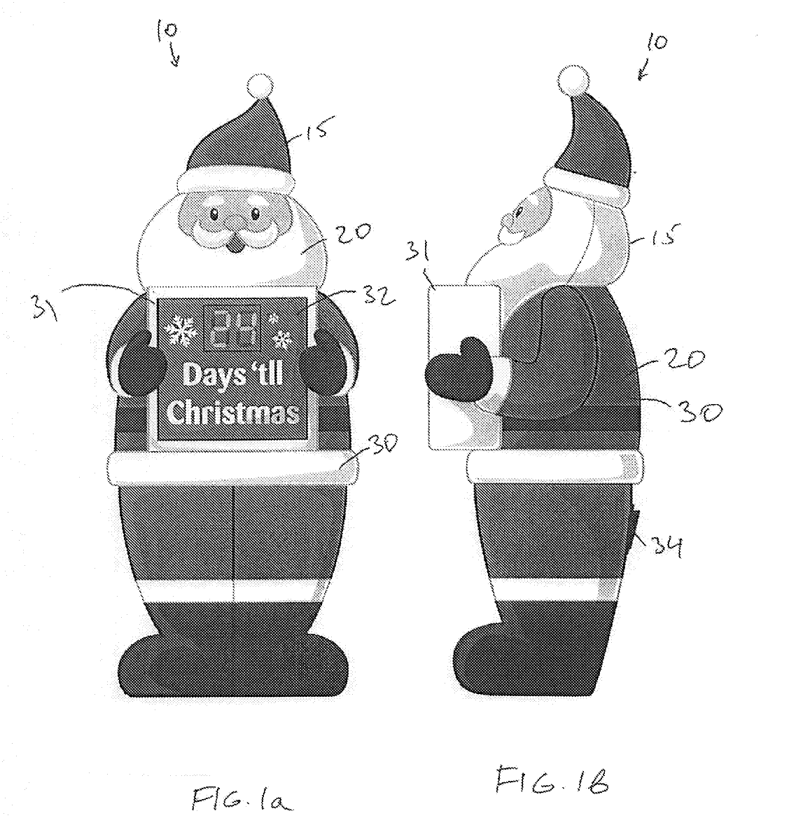

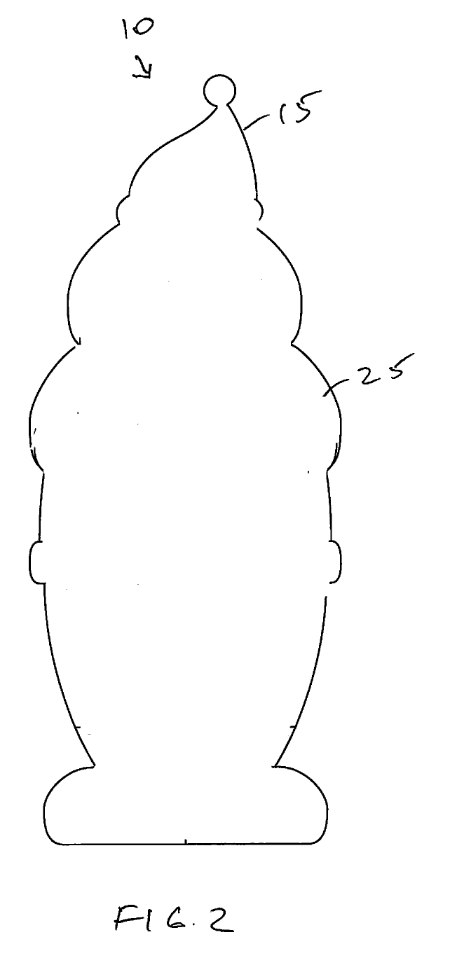

According to some embodiments, an inflatable display assembly 10 is shown in FIGS. 1a-b and is presently disclosed. According to some embodiments, the inflatable display assembly 10 comprises an inflatable display 15. According to some embodiments, the inflatable display 15 comprises an inflatable outer shell 20. The inflatable outer shell comprises an interior surface 25 (shown in FIG. 2) and an outer surface 30 (shown in FIG. 1). FIG. 2 is a cutaway view of the inflatable display 15.

According to some embodiments, the inflatable display 15 comprises at least one fan 34 configured to inflate the inflatable outer shell 20. According to some embodiments, the inflatable outer shell 20 comprises a permeable fabric that allows air to escape at about the same rate as the air being blown into the inflatable outer shell 20 by the at least one fan 34.

According to some embodiments, the at least one fan 34 is implemented as a lightweight plastic sleeveless bearing fan. According to some embodiments, the at least one fan 34 is removable and can be easily removed from its housing for cleaning or replacement whenever necessary.

According to some embodiments, the inflatable display 15 comprises one or more compartments 31 configured to accommodate one or more display assemblies 32.

According to some embodiments, the one or more display assemblies 32 comprise one or more monitors for displaying information, data, one or more images and/or video. According to some embodiments, the one or more display assemblies 32 is a countdown display that counts down from a higher number to a lower number. For example, the one or more display assemblies 32 counts down in increments of years, months, days, weeks, hours, minutes, and/or seconds.

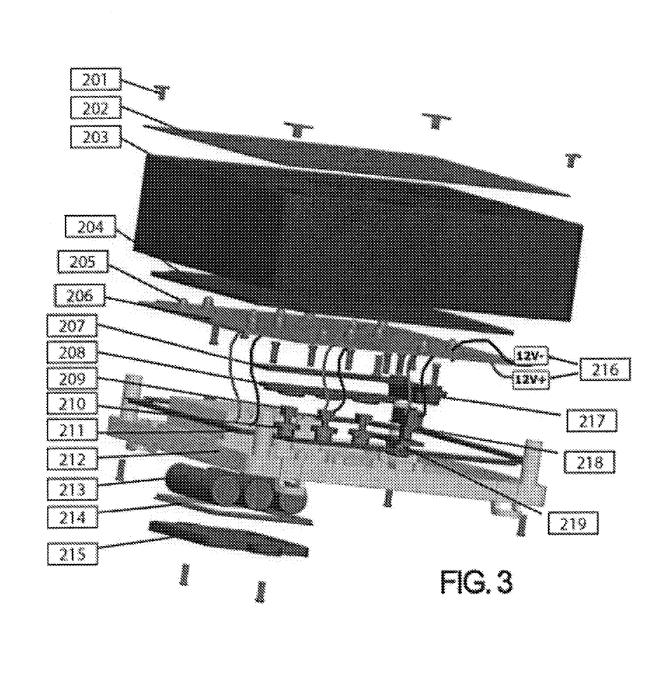

Referring to FIG. 3, according to some embodiments, the one or more display assemblies 32 comprise one or more location pins 201, a front cover 202, a main housing 203, a thin sheet 204, an LED 205, a Printed Circuit Board Assembly (PCBA) with electronic parts 206, a small PCBA 207, a clamping plate 208, one or more switches 209, one or more buttons 210, an O-ring 211, a back cover 212, one or more batteries 213, an O-ring 214, a battery door 215, one or more wires 216, a clamping plate 217, a power source (not shown), one or more on/off switches 218, one or more on/off buttons 219. According to some embodiment, after plugging into the power source (not shown), sliding the “ON/OFF” switch 218 to the “ON” position will switch on the LEDs 205 that light up the segments inside the main housing 203. According to some embodiment, specific LEDs 205 will light up to show 2 decimal numerals that represent, for example, “DAY” on the front panel of a countdown clock. According to some embodiments, the functional buttons 210 can be configured to set the current day and time. According to some embodiments, the digital count down will begin counting down after setting is confirmed. According to some embodiments, the electronic countdown clock displays the days and that change daily. According to some embodiments, the PCBA (printed circuit board assembly) 206 counts the time left to a date of the user's choice and it uses the one or more batteries 213 to maintain memory storage, so that the countdown function stays on even when the adapter is unplugged.

According to some embodiments, the inflatable display assembly 10 and/or the one or more display assemblies 32 comprises a motion detector (not shown) associated with the one or more display assemblies 32. According to some embodiments, the motion detector (not shown) is configured to activate the one or more display assemblies 32 when motion is detected. According to some embodiments, the motion detector (not shown) is configured to have the one or more display assemblies 32 display information, data, one or more images and/or video when motion is detected and to have the one or more display assemblies 32 stop displaying information, data, one or more images and/or video when the motion stops. According to some embodiments, the motion detector (not shown) is configured to have the one or more display assemblies 32 stop displaying information, data, one or more images and/or video when motion is detected and to have the one or more display assemblies 32 display information, data, one or more images and/or video when the motion stops.

According to some embodiments, the inflatable display assembly 10 comprises a speaker (not shown) to play audio. According to some embodiments, the inflatable display assembly 10 comprises a processor (not shown) and a memory (not shown and described in more detail below). According to some embodiments, the speaker (not shown) is configured to play one or more audio files stored in the memory (not shown). According to some embodiments, the speaker (not shown) is configured to play one or more audio files when the one or more display assemblies 32 display information. According to some embodiments, the speaker (not shown) is configured to play one or more audio files received through a radio frequency (RF) circuitry (not shown and described in more detail below).

According to some embodiments, the inflatable display assembly 10 and/or the one or more display assemblies 32 comprises a radio frequency (RF) circuitry (not shown). The RF circuitry (not shown) may be configured to receive and transmit RF signals, also called electromagnetic signals. The RF circuitry (not shown) converts electrical signals to/from electromagnetic signals and communicates with communications networks and other communications devices via the electromagnetic signals. The RF circuitry (not shown) may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry (not shown) may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

According to some embodiments, the RF circuitry (not shown) is configured to allow a user to activate the one or more display assemblies 32 from a remote location. According to some embodiments, the RF circuitry (not shown) is configured to have the one or more display assemblies 32 display information, data, one or more images and/or video when receiving a first signal from the user and to have the the one or more display assemblies 32 stop displaying information, data, one or more images and/or video when receiving a second signal from the user.

According to some embodiments, the inflatable display assembly 10 and/or the one or more display assemblies 32 comprises a memory (not shown). The memory (not shown) may comprise high-speed random access memory and/or non-volatile memory, such as one or more magnetic disk storage devices, flash memory devices, or other non-volatile solid-state memory devices. According to some embodiments, the data, information, one or more images and/or video shown by the one or more display assemblies 32 are stored in the memory (not shown). According to some embodiments, the data, information, one or more images and/or video shown by the one or more display assemblies 32 are downloaded into the memory (not shown) from a remote server and/or storage through the RF circuitry (not shown). According to some embodiments, the data, information, one or more images and/or video shown by the one or more display assemblies 32 are streamed into the memory (not shown) through the RF circuitry (not shown).

Although the inflatable display 15 is represented as a Santa Clause, it is to be understood that the inflatable display 15 can be any shape and/or size and is not limited to being only a Santa Clause. According to some embodiments, the inflatable display 15 is shaped as a human being, animal, insect, fictional character, geometric shape, building, structure or any other shape.

According to some embodiments, the one or more display assemblies 32 are powered by the at least one fan 34.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . . ”

What is claimed is:

1. An inflatable display comprising:
an inflatable outer shell comprising at least one compartment configured to accommodate at least one display assembly;
at least one fan providing a continuous air flow to inflate the inflatable outer shell; and
at least one display assembly disposed within the at least one compartment and configured to display information.

2. The inflatable display of claim 1, wherein the information displayed by the at least one display assembly is time, date, one or more images or video.

3. The inflatable display of claim 1, wherein the at least one display assembly comprises a monitor.

4. The inflatable display of claim 1, wherein the at least one display assembly is removable.

5. The inflatable display of claim 1, wherein the at least one display assembly is powered by the at least one fan.
